(19) United States
(12) Patent Application Publication
(10) Pub. No.: US 2023/0300113 A1
(43) Pub. Date: Sep. 21, 2023

(54) Network Firewall Rules Management Control System

(71) Applicant: Robert Franklin Terry, Old Hickory, TN (US)

(72) Inventor: Robert Franklin Terry, Old Hickory, TN (US)

(21) Appl. No.: 18/121,485

(22) Filed: Mar. 14, 2023

Related U.S. Application Data
(60) Provisional application No. 63/320,575, filed on Mar. 16, 2022.

(51) Int. Cl. H04L 9/40

(52) U.S. Cl. CPC H04L 63/0263; H04L 63/1433

(57) ABSTRACT

A method of establishing a programming interlink, then monitoring, managing, controlling and reporting the Microsoft Windows Defender Firewall Rules subsystem. Specifically, after establishing a Component Object Module (COM) binary interface program directly into the Firewall Rules subsystem, and then executing a series of parallel threads that perform a query gathering firewall rules data, establishing a configuration baseline, then continuously running 24×7/365, which monitors the current state of all Windows Defender Firewall Rules. Moreover, creating (starting) another series of text-based console utility programs, which run 24×7/365 that also includes a text-based piped shell utility program interface into the Windows Powershell.exe, which can receive instructions from the COM binary interface program, and process any information that includes transmitting data, regarding any unauthorized change to the established baseline.

The current application claims a priority to the U.S. Provisional Patent application Ser. No. 63/320,575 filed on Mar. 16, 2022.

This current patent application also references the CDS U.S. Pat. No. 10,630,708 specifically in Claim's No. 10, Instant Messaging technology

### FIELD OF INVENTION

The present disclosure generally relates to field of operating system (O/S) utility programming. More specifically, the present disclosure relates to methods of extracting data from a query, establishing a baseline of data based on the query, then creating a series of parallel threads to continuously monitor, detect, immediately retore and transmit communications within a real time environment, in order to report unauthorized and/or malicious activity.

### BACKGROUND OF INVENTION

Over the past 5 years network defense systems have grown exponentially in complexity. Since the outbreak of COVID-19, more and more IT professionals began to work from home. Many of these IT professionals still work from home, and with the continuing rise of gas prices in the United States, the work-from-home IT professional may be the new wave of the future. As world events continue to unfold in Europe, with the Russian invasion of Ukraine, and the economic warfare the United States and the European Union (EU) have initiated against Russia, more and more hostilities are unfolding worldwide that include strained U.S. relations with China over Taiwan, and Iran has recently fired missiles at what Iran reported was an Israeli military installation, and actually hit a U.S. Consulate. In all of these strained international relationships, cyber networks are considered a prime target in attacking and stealing critical information, continuous network monitoring by unauthorized entities, and the potential destruction of targeted networks, which could result in a shut-down in critical infrastructure such as in power plant production (electricity), water purification, transit systems, financial systems, medical, shipping, etc. The world witnessed in 2020 and 2021 the SolarWinds hack, which severely affected thousands of corporations and government organizations in the U.S. and worldwide. The SolarWinds organized worldwide attack was so successful, because the hacker's studied vulnerabilities within third-party software solutions deployed globally, and found a way to access those third-party solutions without detection, and continued to extract data for well over a year, because their malicious activity was considered authorized by network defense/detection technologies.

As network security technology continues to evolve, many major worldwide hacks (breaches), are most likely still underway, and have possibly gone completely undetected, with billions of dollars in intellectual property being stolen by the hackers. New security architectures are being introduced, such as the Zero Trust architecture to replace what is now considered by many cyber technology professionals as a failing architecture, which is the current Defense-In-Depth architecture.

However, hackers and hacking groups worldwide still persist in their efforts to discover new ways (methods) to successfully breach networks by using a mechanism that is considered by the targeted network as an authorized and acceptable process and/or application to transmit/receive without interference from the local network defense/detection system. In extremely simple terms, the hackers hope to gain access and take control of a process and/or application that has been approved by the network defense system, no matter what defense architecture has been implemented, such as defense-in-depth, zero trust, etc.

It has been well documented over the past year that well organized and well-funded hacking groups are hiring the best minds worldwide and also offering the highest pay. In simple terms, these hacking groups are utilizing highly paid individuals to perform sophisticated reconnaissance on targeted networks, and building “exact duplicates” of the network architecture they will attack, in order to better understand, and hopefully determine a “breach point” where they can access (enter) the targeted network completely undetected, and then monitor and extract data for financial gain, or possibly (eventually) destroy the network to bring great harm, which may be financial harm to an economic system or physical harm to a population such as in shutting down electricity, polluting water with poison or damage to a nuclear power plant, medical system, air traffic or satellite system, etc.

As these new and advanced security architectures begin to unfold, one of the most critical components in all these architectures is the firewall. Within the past 10 years firewall technology architectures have continued to evolve, with several advancements made in intercepting communications BEFORE it is allowed to proceed successfully to transmit to/from (through) the firewall, and also analyzing the communications for malware, before it is allowed to proceed.

The firewall itself is now accompanied by many other technologies to assist in the methodology of implementing a “layered defense” to protect networks.

However, in applying an old reliable theory, which was arguably originated by the Franciscan Frier William Occam that is known as Occam's Razor, which is explained as in the most complex of all environments and problems, usually the simplest and most common-sense explanation is the correct answer.

In applying the theory of Occam's Razor to modern state-of-the-art network defense systems, the hackers also realize that network security administrators want a single management console, which is commonly referred to as a Security Information and Event Management System (SIEM). The SIEM takes a “feed” from the trusted security solutions within the defense system, and one of those trusted “feeds” is from the firewall (events), or several firewalls (events), deployed throughout the security architecture of the defense system.

Therefore, if a hacker or group of hackers can successfully interlink and exploit a (trusted) firewall within the targeted security architecture, then the hackers unauthorized and malicious activity may be considered as authorized and legitimate, and allowed to proceed by the network defense system, without any notification to the network security administrative staff.

Which leads to the security architecture designed, developed and produced by Microsoft that started in 2003, and is named Windows Defender. The Windows Defender security architecture consists of many components, and has been under continuous design and development by Microsoft for the past 20 years.

One of the key security components of Microsoft Windows Defender, is the internal firewall. For the past several years, Microsoft has published specifications to allow any third-party developer to create and establish and interface into the Windows Defender Firewall RULES sub-system.

Firewall RULES are described as those rules that are created and assigned to a specific process, application or to the entire computer (device), which will allow or deny that process, application or computer (device), to transmit communications to one, a range of, or any IP address (outbound rule), and/or receive communications from one, a range of, or any IP address (inbound communications). Firewall RULES can be created to ONLY transmit communications out (outbound only rule), or to ONLY receive communications (inbound only rule).

The Microsoft Windows Defender specifications are published on the Microsoft Developer Network (MSDN) website to legally allow any third party to establish an interlink into the Windows Defender Rule subsystem by using a programming method called, 1) Component Object Modeling (COM) binary programing interface, or by using other Microsoft applications such as, 2) The PowerShell.exe application and utilizing command line instructions directly into the Windows Defender Rule subsystem, or 3) Initializing a command prompt by executing CMD.EXE, and utilizing command line instructions directly into the Windows Defender Rule subsystem.

If hackers were to successfully penetrate a Microsoft defended network and establish a successful interface into the Windows Defender Firewall Rule subsystem and add a rule, or modify an existing rule to ALLOW the hacker activity to proceed, then there is an extremely high probability that the hackers can remain INSIDE of the network, undetected and transmitting (stealing) all network information without being detected, reported and/or stopped by the network defense system.

Therefore, there are extremely important reasons WHY there is a critical need for an INDEPENDENT THIRD-PARTY SOLUTION to monitor and manage the Windows Defender Firewall Rules subsystem; 1) One of the oldest philosophical practices implemented in a sophisticated security system (environment) is a “two key system”. In this case, there would be a third-party monitoring the Windows Defender Firewall Rules subsystem, which is the same as implementing a “two key system”, and 2) Microsoft's publication of the Windows Defender Firewall Rules subsystem interface, has gone as far as Microsoft deploying critical operating system processes with each O/S process specifically having an independent interlink established into the Windows Defender Firewall Rule subsystem. Moreover, Microsoft's major office applications such as Outlook, Teams, Internet Explorer (MS Edge), and many other Microsoft applications that are standard within the O/S such as the Phone, Solitaire, etc. have an established independent interface into the Windows Defender Firewall Rules subsystem.

The REALITY is that the evolution of security within the Microsoft operating system architecture, has evolved from the Firewall having 100% authority over all executing processes and applications, to many of the executing Microsoft processes and applications within the O/S having an independent firewall interlink established, which gives the processes and applications total authority over the firewall itself. In simple terms, executing O/S processes and applications can now issue their own instructions to the Windows Defender Firewall, and it is they that have control over the firewall, not the firewall with control over the executing O/S processes and applications.

Therefore, with so many active Microsoft O/S processes and applications with authority to issue instructions and create their own rules (security privileges) within the Windows Defender Firewall Rule subsystem, if any of these processes or applications are successfully exploited, then the ramifications would be a major and massive security disaster (breach) within any network. The hackers would be able to successfully transmit to/from an IP address(es) as authorized activity, and never be detected and reported by any type of network defense system.

### SUMMARY

Disclosed are specific methods that after establishing a successful INDEPENDENT THIRD-PARTY interface into the Windows Defender Firewall Rule sub-system, to extract all firewall rules (inbound, outbound, etc.), then storing each rule into memory and/or creating and saving those rules to a data file, or any form of database, then establishing a 24×7/365 monitoring system into (and over) the Windows Defender Firewall Rule subsystem by executing a series of parallel threads, in order to detect, transmit, and immediately restore any unauthorized modification within the Windows Defender Firewall Rules subsystem.

### BRIEF DESCRIPTION OF THE DRAWINGS

FIG. 1 illustrates a typical operating environment of a traditional network with workstations (desktop computers, laptops, etc.), and a server configured together to process communications data associated with each network asset, such as, for example, but not limited to, network servers, in accordance with various embodiments disclosed herein.

FIG. 2 illustrates a typical operating environment of a CLOUD NETWORK with workstations (desktop computers, laptops, etc.), and servers configured together to process communications data associated with each network asset, such as, for example, but not limited to, network servers, in accordance with various embodiments disclosed herein.

FIG. 3 illustrates a typical operating environment of a desktop workstations configured together with another workstation acting as a server with the Remote Host Management Control System utilized in CDS U.S. Pat. No. 10,630,708 Claim No. 10, specifically instant messaging technology, processing communications data specifically associated with the Microsoft Windows Defender Firewall Rules subsystem operating on each Microsoft computer workstation

FIG. 4 illustrates how workstations alone, without server technology, can be utilized to successfully implement (deploy) the Network Rules Management System Client software, and the Remote Host Management Control System Server software.

FIG. 5 illustrates an INDEPENDENT THIRD-PARTY text-based console program [ONE] starting as a service and executing within Session ZERO (0) of the Microsoft O/S, which establishes an interlink via component object modeling (COM) into the Windows Defender Firewall RULES subsystem, which also initiates a series of parallel threads to process secure command messages. A second text-based console program [TWO] starting as a service, which creates an instance of the Microsoft Windows PowerShell.exe, within a secure PIPED INTERFACE (wrapper), which controls all input and output (I/O) generated by the PowerShell.exe instance that also initiates a series of parallel threads to process secure command messages. A third text-based console program [THREE] is executed that creates an interface into the Microsoft O/S process stack that monitors all executing processes and the DLL's associated with each executing process that also initiates a series of parallel threads to process secure command messages. A fourth text-based console program [FOUR} is executed that is capable of transmitting all activity via secure communications to the INDEPENDENT THIRD-PARTY Remote Host Management Control System.

FIG. 6 is text-based console program ONE extracting all Windows Defender Firewall RULES subsystem, and creating a storage medium, whether in memory or in any type of file or database that creates a BASELINE of all rules. Then text-based console program ONE executing a series of parallel threads to monitor the RULES subsystem by comparing the established baseline rules, to the actual Windows Defender Firewall Rules subsystem. If text-based console program ONE detects an unauthorized modification or new firewall rule created, a secure message is sent via parallel threads to text-based console program TWO and to text-based console program FOUR, to transmit to the INDEPENDENT THIRD-PARTY Host Remote Management Control System.

FIG. 7 is text-based console program TWO receiving secure message instructions from text-based console program ONE, to update and return the Windows Defender Firewall Rules subsystem back to its original established baseline.

FIG. 8 is text-based console program THREE searching and traversing the process stack maintaining a continuous monitor on all executing processes and applications, and specifically monitoring all processes and applications that have an established interface directly into the Windows Defender Firewall Rule subsystem, and to update text-based process ONE and text-based process FOUR with said information.

FIG. 9 is text-based console program FOUR initiating TCP communications and establishing a connection with the Remote Host Management Control System, and also starting parallel threads to receive messages from text-based console programs ONE, TWO and THREE.

FIG. 10 is the Remote Host Management System, which receives real-time secure communications from each text-based console program ONE, deployed on each Microsoft, desktop, laptop, server, etc. which in turn can provide automated instructions, or wait for the input of instructions from authorized network administration personnel.

FIG. 11 is the Network Firewall Remote Management Control System on a “stand alone” Microsoft computer, whether it is a workstation, laptop PC, Note Book or server. The Remote Host Management Control System is a modified configuration of a Graphic Unit Interface (GUI), which reads the parallel threats output of all four text-based console programs, and provides the end-user a GUI management window to view and manage all Windows Defender Firewall Rule subsystem events.

### DETAILED DESCRIPTION OF THE INVENTION

All descriptions are for the purpose of showing selected versions of the present invention and are not intended to limit the scope of the present invention. In the description herein, general details of the present invention are provided in flow diagrams to provide a general understanding of the programming methods that will assist in an understanding of the embodiments of the present invention. One skilled in the relevant art of programming will recognize, however, that the present invention can be practiced without one or more specific details, or in other programming methods. Referenced throughout this specification to “one embodiment” or “an embodiment” means that a particular feature, structure or characteristic described in connection with the embodiment is included in at least one embodiment of the present invention. Thus, the appearance of the phrases “in one embodiment” or “in an embodiment” in places throughout this specification are not necessarily all referring to the same embodiment. Furthermore, the particular features, structures, or characteristics may be combined in any suitable manner in one or more embodiments.

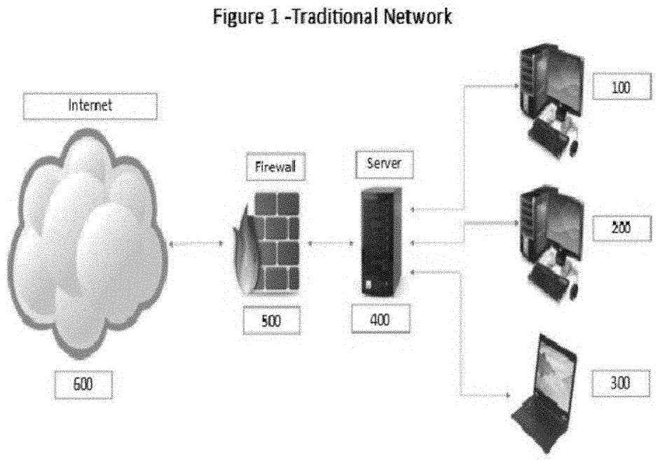

FIG. 1 represents an illustration of an operating environment of a traditional network, with Microsoft workstations [100] connected to a Microsoft server [400], which all have access to the worldwide internet [600] protected by the firewall [500]. This illustration represents a simple network environment where many additional devices may be deployed.

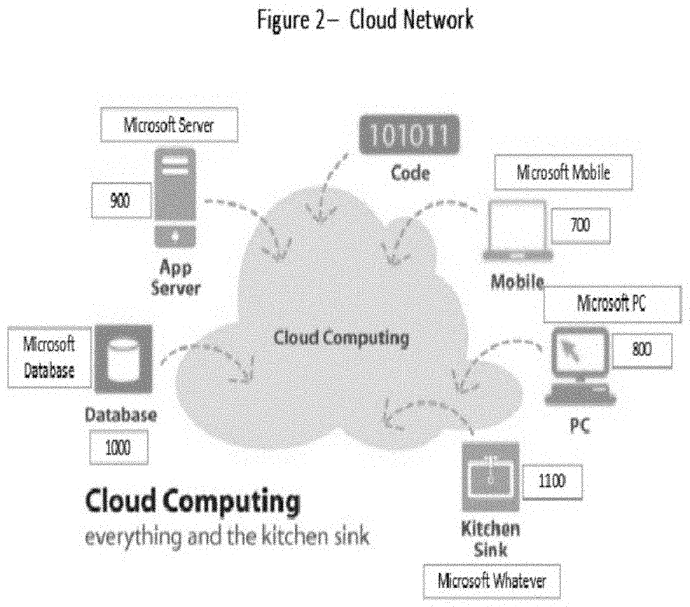

FIG. 2 represents an illustration of an operating environment of a typical cloud network, which Microsoft PCs (workstations) [800], servers [900], mobile devices [700], may all be connected via the cloud to database(s) [1000], or any other device (kitchen sink) [1100].

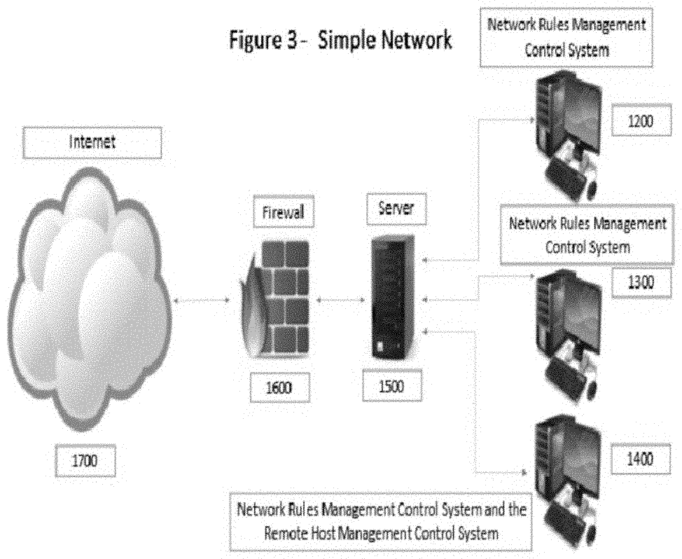

FIG. 3 represents an illustration of how the Network Firewall Rules Management Control system may be deployed on Microsoft workstations [1200], [1300], [1400], and how BOTH the Network Firewall Rules Management Control System (client) AND the Remote Host Management Control System (server) [CDS U.S. Pat. No. 10,630,708 Claim No. 10, specifically instant messaging technology] may be deployed on the same workstation.

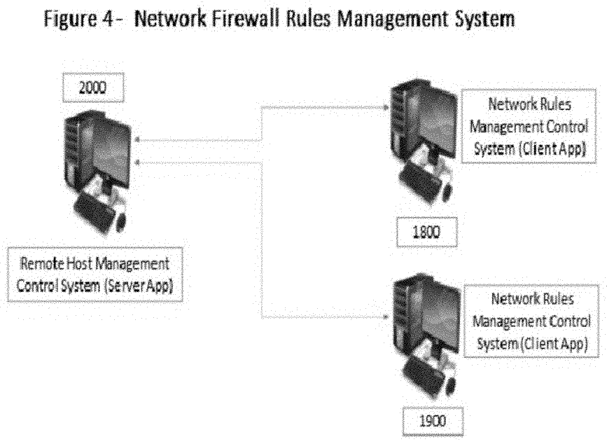

FIG. 4 represents an illustration of a subset of a traditional and/or cloud network (combination of both), in how the Network Firewall Rules Management Control System [1800], [1900], [2000], can be deployed and managed without the need of a traditional server.

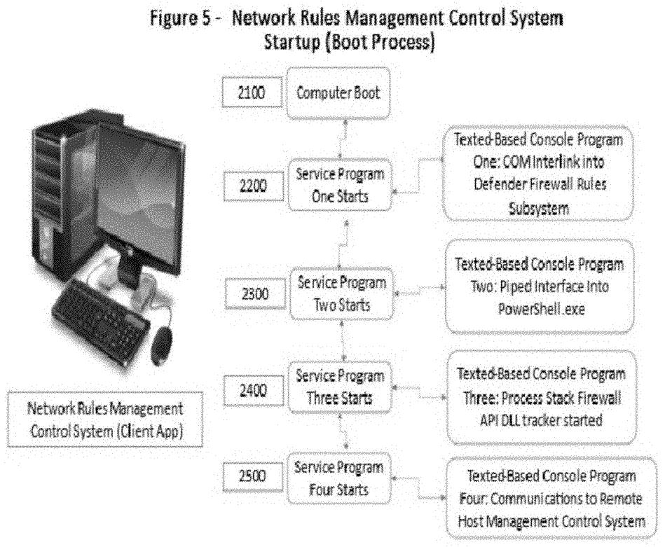

FIG. 5 represents an illustration of how the Network Firewall Rules Management Control System is booted [2100] at startup (power on) in a Microsoft computer. As illustrated in the diagram, a series of service programs [2200], [2300], [2400] and [2500], each start a text-based console program ONE, TWO, THREE and FOUR.

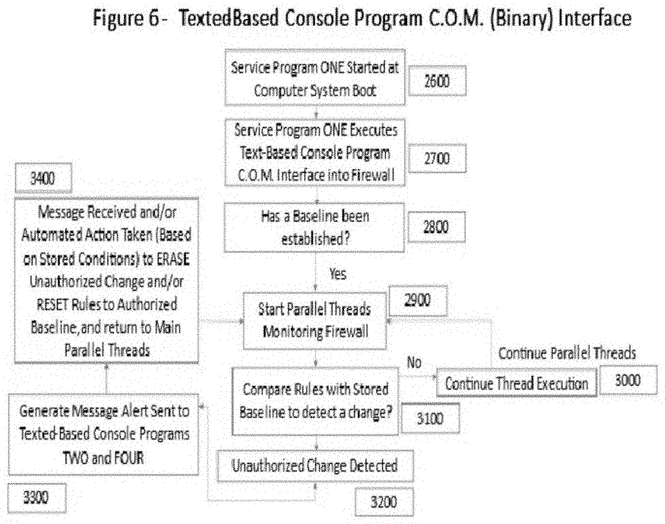

FIG. 6 represents an illustration of how the service program [2600] starts the text-based console program that establishes an interlink (interface) [2700] into the Windows Defender Firewall, and begins to monitor inbound/outbound RULES subsystem, and once a baseline [2800] of all rules has been established, then it executes parallel threads [2900] that begin to monitor the Defender Rules subsystem to detect an unauthorized change [3100]. Once a cycle (loop) of the parallel thread is finished, if no change has been detected, the text-based program continues its cycling [3000] 24×7/365 while the computer is operational with power. However, if an unauthorized change is detected [3200], a message alert is generated and sent to text-based console programs TWO and FOUR [3300], and corrective action is taken by automated stored conditions and/or instructions received [3400], in order to return the Windows Defender Firewall Rules subsystem to the original (stored) baseline [2800] configuration.

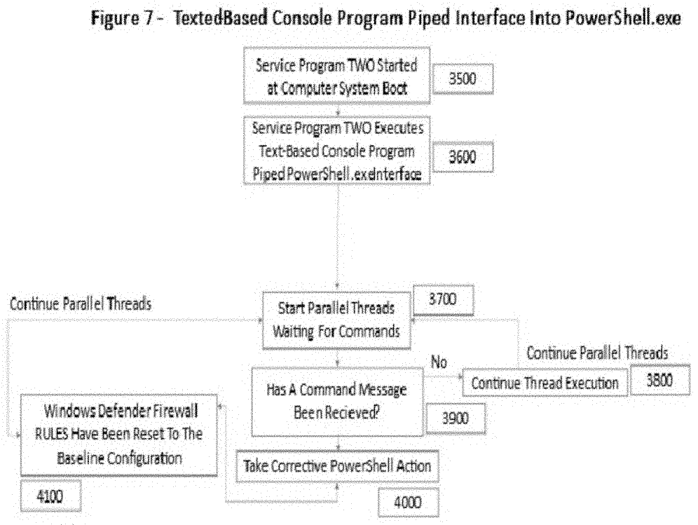

FIG. 7 represents an illustration of how the service program [3500] starts text-based console program TWO and creates a piped INPUT/OUTPUT interface into a controlled session of POWER SHELL (PowerShell.exe) [3600]. A series of parallel threads are executed [3700], waiting to receive commands from text-based console program ONE, and if no commands are received, the parallel threads continue their execution [3800]. If command instructions are received [3900], then action is taken [4000] by resetting the Windows Defender Firewall Rules subsystem to its original baseline configuration as displayed in FIG. 1 [2800].

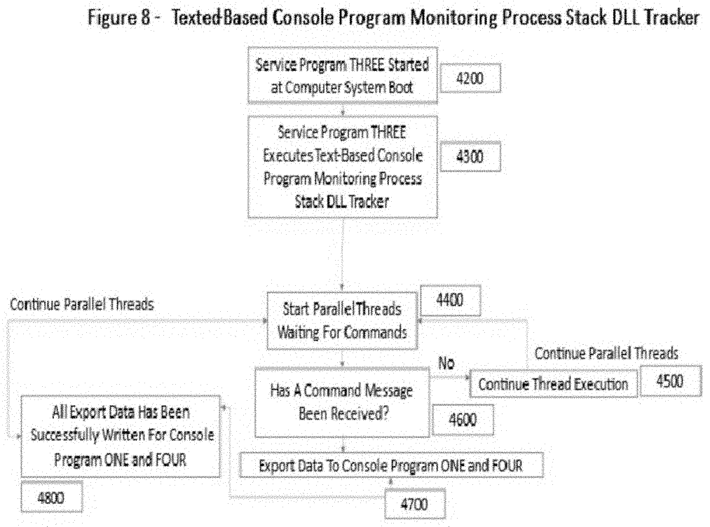

FIG. 8 represents an illustration of a service program THREE executing [4200] a text-based console program, which establishes an interface (interlink) into the executing process stack [4300], and parallel threads [4400] are started, in monitoring each executing “.exe”, and also dynamically TRACING each active “.dll” (dynamic link libraries) with an established interlink into each “.exe”. The KEY is searching for those “.dll” that create a direct link into the Windows Defender Firewall subsystem, which can instruct the Windows Defender Firewall to create new firewall rules and/or update existing firewall rules. If a command message has been received [4600], then the DLL activity that specifically pertains to the Windows Defender Firewall subsystem is EXPORTED [4700], and successfully written to a file (ASCII text, or structured database) [4800], for text-based console programs TWO and FOUR.

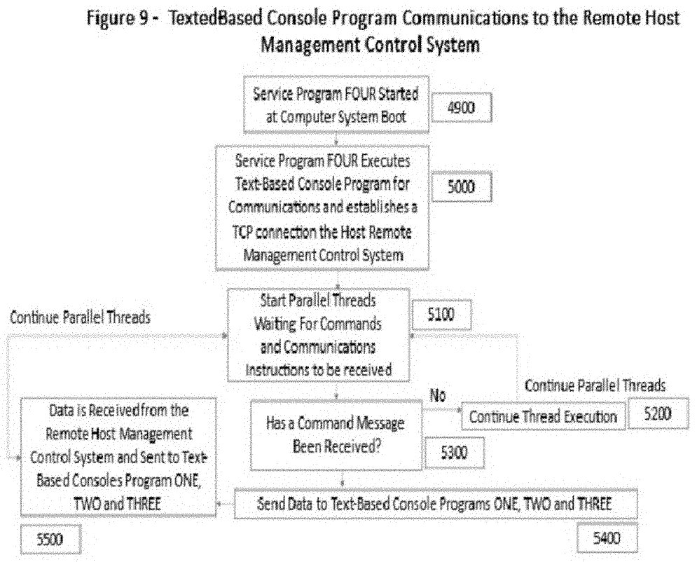

FIG. 9 is an illustration of service program FOUR that executes the text-based console program for communications to be established by a TCP connection into the Remote Host Management Control System [5000], which is utilizing the methods in [CDS U.S. Pat. No. 10,630,708 Claim No. 10, specifically instant messaging technology]. The text-based console program is waiting for communications instructions from the Remote Host Management Control System, or for instructions from the text-based console programs ONE, TWO or THREE [5300], and depending on the DIRECTION of the instructions received, text-based console program FOUR will either receive or transmit communications to the Remote Host Management Control System, or process the communications and update text-based console programs ONE, TWO or THREE [5400], [5500].

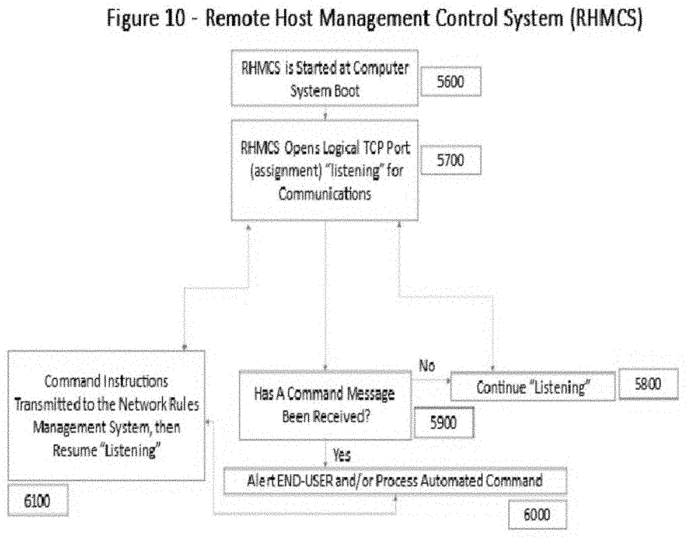

FIG. 10 is an illustration of the Remote Host Management Control System that is utilized in [CDS U.S. Pat. No. 10,630,708 Claim No. 10, specifically instant messaging technology], which starts at the computer system boot [5600], which then opens a defined logical port [5700] and begins “listening” for communications to be received from any Microsoft workstation (PC, laptop, notebook, server, etc.) that may have the Network Firewall Rules Management System installed, and receives communications [5200]. Once the communications are received [5900], automated instructions may be executed, or instructions may be entered by the end-user [6000], and those automated and/or command instructions are transmitted back to the Network Firewall Rules Management System [6100]. The parallel threads continue to cycle, waiting for communications to be received [5800].

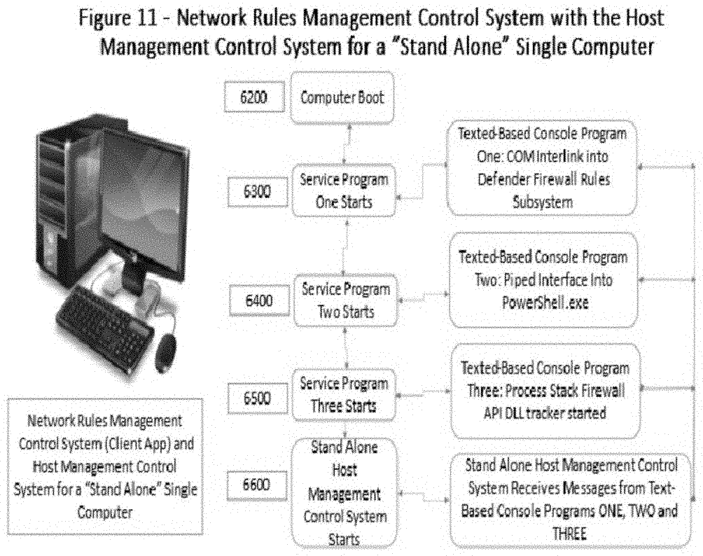

FIG. 11 is an illustration of a “stand alone” computer with a combination of the Network Rules Management Control System combined with the Remote Host Management Control System configured for an end-user with a Microsoft workstation (PC, laptop, Note Book and even possibly a server O/S), which is not connected to a network. As the computer boots [6200], each service program starts, [6300], [6400], [6500], which in turn starts each text-based console program ONE, TWO and THREE. All text-based console programs are communicating directly with a Remote Host Management Control System also installed on the workstation [6600], which is a modified configuration utilized in order to provide direct management control to the end-user who is residing at the workstation.

### Exemplary Embodiment

According to an exemplary embodiment of the present disclosure, monitoring of the Windows Defender Firewall Rules systems activity, which specifically involves the continuous monitoring of Windows Defender Firewall Rules subsystem (desktop, laptop, etc.) [1800], [1900], then transmitting the IPv4 or IPv6 communications data from the text-based console program [FOUR], to the Remote Host Management Control System that is utilized in [CDS U.S. Pat. No. 10,630,708 Claim No. 10, specifically instant messaging technology]. Accordingly, the present disclosure provides a method of designing text-based console programs that reside and execute in Session 0 within a Microsoft O/S, which takes into account each of the specific steps previously identified.

Accordingly, in an instance, the present disclosure provides detailed methods of designing Microsoft system services, console programs for establishing a baseline, performing a query, detecting changes, and transmitting those changes and/or updating the immediate end-user with critical information necessary in order to detect, stop and reverse a Windows Defender Firewall unauthorized configuration change that may result in the loss of confidential and/or classified corporate or government data.

The detailed methods may be deployed on any Microsoft computer (workstation, PC, laptop, note book, server, etc.), deployed inside any network (traditional, cloud or combination of both), or on a stand-alone Microsoft computer.

1. After the text-based console program establishes a successful interface into the Windows Defender Firewall Rules subsystem, a method of writing all data to active memory or to a file, whether that file is an unstructured ASCII text file or a database of any kind, in order to establish an INDEPENDENT THIRD-PARTY storage point in memory or written to a physical storage medium (hard drive, external drive, USB, etc.)

2. A method of monitoring the Windows Defender Firewall Rules subsystem, and comparing the active rules to active memory or to a file, whether that file is an unstructured ASCII text file or a database of any type, in order to detect any kind of unauthorized change and/or modification to the Windows Defender Firewall Rules subsystem.

3. A method of identifying any type of unauthorized change and/or modification within the Windows Defender Firewall Rules subsystem in a real-time/instantaneous environment.

4. A method of establishing an interface into the Microsoft O/S process stack, and continuously tracking all active processes that have an established interlink into the Windows Defender Firewall Rules subsystem.

5. A method of transmitting the unauthorized change and/or modifications within the Windows Defender Firewall Rules subsystem to a Remote Host Management Control System, which is utilized in [CDS U.S. Pat. No. 10,630,708 claim No. 10, specifically instant messaging technology].

6. A method of instantly updating and returning the Windows Defender Firewall Rules subsystem to its original established baseline configuration.

7. A method of gathering and transmitting all established Windows Defender Firewall Rules (subsystems) deployed throughout a network, whether it is a small traditional network, or a worldwide cloud network, and performing an analysis on all Windows Defender firewall rules, in order to identify possible security “holes” that might be created by a process and/or application.

8. A method of combining the Network Firewall Rules Management Control System with the Remote Host Management Control System that is utilized in [CDS U.S. Pat. No. 10,630,708 claim No. 10, specifically instant messaging technology] into a single “stand alone” self-contained solution (configuration package), which can be deployed on any Microsoft desktop, laptop PC, Note Book or server, where the end-user has the full suite of capabilities to view and manage the Windows Defender Firewall Rules subsystem from a single computer, not connected to any network.

9. While the specific methods disclosed within this embodiment utilize specific service programs to start and execute each text-based console program, this embodiment claims any method that utilizes a single service program, or multiple service programs that may start an interface into the Windows Firewall Defender Rules subsystem, in order to create a baseline and monitor for any unauthorized modification within the Windows Defender Firewall Rules subsystem.

10. While the specific method disclosed within this embodiment use general examples creating a baseline, that baseline may be created by writing to any storage mechanism, such as an ASCII text file, any structured database, or storing the data directly into memory, for the purpose to compare the active Windows Defender Firewall Rules to those that are stored in any file type or active memory.

11. While the specific methods disclosed within this embodiment do not mention a specific programming language, such as C, C++, C#, Visual Basic, Java, .NET, etc., any programming language (mechanism) that allows one skilled in the art to develop an interface directly interlinked into the Windows Defender Firewall Rules subsystem, SPECIFICALLY for the purposes of maintaining a configuration control baseline to detect unauthorized changes, alert and/or automatically reset to its authorized baseline configuration.

12. While the specific methods disclosed within this embodiment uses specific examples of Microsoft workstation, laptop, server computer operating systems, any Microsoft operating system, platform (or device) that utilizes the Windows Defender Security (Firewall) system, as it relates to network operations from the basic stand-alone computer, to mobile devices and all traditional and/or cloud network operations.

13. While specific methods (mechanics) are detailed in how to establish an interface into the Windows Defender Firewall subsystem and then perform a 24×7/365 query to maintain the security integrity of the Defender Firewall Rules subsystem, the methods detailed in this embodiment would be applicable to any Microsoft specification change and/or modification to the Windows Defender Firewall programming interface (interlink), and the same methods (mechanics) would be utilized with any change, which includes any new Microsoft programming method to establish a new form of interface into the Windows Defender Firewall subsystem.
